(19) United States
(12) Patent Application Publication
(10) Pub. No.: US 2007/0147352 A1
(43) Pub. Date: Jun. 28, 2007

(54) ACCESS POINT AND WIRELESS AUDIO BOTH HAVING SELF-SUSTAINED POWER SUPPLY APPARATUS

(75) Inventor: Neng-Chia Lee, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: MEMETICS TECHNOLOGY CO., LTD., Taipei (TW)

(21) Appl. No.: 11/616,424

(22) Filed: Dec. 27, 2006

(30) Foreign Application Priority Data
Dec. 27, 2005 (TW) 094146865

(51) Int. Cl. H04L 12/66; H04B 1/38

(52) U.S. Cl. 370/352; 455/73

(57) ABSTRACT

The provided access point includes a self-sustained power supply apparatus, a base station coupled to the power supply apparatus and receiving a first DC power supply, and an antenna set coupled to the base station. In which, the power supply apparatus further includes an autogenic energy generating apparatus generating an AC power supply, a switch turning on and off the generating apparatus, a rectifier coupled to the generating apparatus and rectifying the AC power supply to a second DC power supply, a regulator coupled to the rectifier and regulating the second DC power supply to generate a third DC power supply, and a DC/DC converter coupled to the regulator, receiving the third DC power supply and generating the first DC power supply. A wireless audio system having two self-sustained power supply apparatuses are also provided.

### FIELD OF THE INVENTION

The present invention relates to the configurations of an access point having a self-sustained power supply apparatus and a wireless audio having a self-sustained power supply apparatus. More particularly, the present invention relates to the configurations of the access point and the wireless audio both having the self-sustained power supply apparatus, in which the self-sustained power supply apparatus includes an autogenic energy generating apparatus providing the power supply required by the access point and the wireless audio.

### BACKGROUND OF THE INVENTION

Electronic equipment would depend on an external power supply unless a battery is employed. For electronic equipment using a battery, the use time of the electronic equipment would be limited by the battery life time, thus the power status of the battery needs to be checked and a bad/dead battery needs to be changed repeatedly. Right now, the waste batteries are not properly handled and causing the globally environmental pollution concerns. Since the totally recovery and reuse of the waste battery so as to prevent further environmental pollution is not well taken, using the disposable battery is not a good alternative from the environmental protection point of view. Besides, even if the rechargeable battery is employed, still the use time of the electronic equipment is still limited by the battery life time. Each time when the rechargeable battery is used and dead, the battery needs to be recharged by a charger for a relatively longer charging time before it can be reused. Thus, at least two sets of rechargeable batteries needs to be prepared to keep the electronic equipment handy not to mention that changing the battery repeatedly is quite inconvenient. Therefore, using the rechargeable battery is not a good alternative too. On the other hand, the installation location of the electronic equipment, which depends on an external power supply, would be limited by where the external power supply is located. For example, when an access point is installed, the location of the AC power supply must be considered (where is the socket? it is usually an indoor AC power supply). However, the base station needs to be installed in the central location among the plurality of computers each having a wireless network device and served by the access point such that the access point could have a relatively better effectiveness. Thus, the access point does have its limits on choosing the proper installation locations. Please refer to FIG. 1, which is the schematic diagram showing the configuration of a conventional LAN 1. The LAN 1 includes an access point 11, a LAN switch (it is one of a switch and a hub) 12, an Ethernet connection port and a plurality of computers each having a wireless network device (including notebooks and desktop computers) 13. Thus, to solve the conflict regarding where the socket of the power supply is located may not be exactly the same as where the base station shall be located for a better performance of the access point, i.e. in the central location among the plurality of computers each having a wireless network device. Similarly, the installation location of a loudspeaker enclosure of a wireless audio must also consider where the socket of the power supply is. Frequently, this would result in either the wireless audio could not be installed at the places having the best sound effects, or the user could not set up the audio at a preferred temporary location, e.g., a place close to the outdoor yard of the user's house, which would cause the inconvenience of the user. Furthermore, the existing of the cable/power supply lines of the audio is one of the reasons to jeopardize the indoor neatness. Currently, there are wireless audio having battery and employing the wireless transmission technology on the market. However, the wireless audio employing the batteries is facing the same problem just like the electronic equipment employing the batteries as aforementioned.

FIG. 2 is the schematic diagram showing the configuration of a conventional wireless audio 2 employing batteries and wireless transmitting technology. The wireless audio 2 includes a main unit 21, at least a loudspeaker enclosure 22 and a remote control 23 as shown in FIG. 2. Thus, how to solve the problems that the battery power needs to be checked frequently, bad/dead battery needs to be changed frequently, the dumped waste battery would cause the environmental pollution, the rechargeable battery would need frequently recharging to be reused, and the installation location of the loudspeaker enclosure is limited to the location of the socket of the external power supply is also what the present invention is trying to solved.

Currently, a device generating an autogenic energy continuously, which could be employed in driving a generator so as to generate an AC/DC output voltage, is proposed in U.S. Pat. No. 6,731,035. In the '035 Patent, the provided device is driving a flywheel via the interactions between two permanent magnets to generate a kinetic energy continuously. However, the preferred embodiment and the relative contents of the '035 Patent are focused on expressing how a proposed configuration of the proposed device could be employed to generate the autogenic energy continuously (see FIG. 3) but nothing regarding how to really use it in certain area is mentioned. Please refer to FIG. 3, an autogenic energy generating device 3 includes a base 322, a first magnetic device 350 having a first magnet 351, a second magnetic device 330 having a second magnet 331, a transmission member 320, and a linking device 340. Furthermore, the transmission member 320 includes a horizontal shaft 321 (the second magnet 331 is fixed to a rectangular intermediate portion 3211 of the horizontal shaft 321), the base 322 includes a first support plate 3221(having a guide slot 3223) and a second support plate 3222, and the linking device 340 includes a linking rod 342, a connection rod 343 and a flywheel 344, which is employed to rotate the transmission member 320 continuously. Though, the '035 Patent provides a simple configuration of the autogenic energy generating device 3 and the operational principles of the device 3, but nothing is mentioned regarding how the device 3 is employed to drive an AC/DC generator to generate an AC/DC power supply to be used in the related electronic equipment, e.g., the access point and the wireless audio of the present invention.

Since the DC generator has an extra commutator than the AC generator, thus relatively the DC generator has a more complex configuration and a higher manufacturing cost than those of the AC generator. Therefore, a self-sustained power supply apparatus includes an autogenic energy generating apparatus having the autogenic energy generating device and an AC generator, a rectifier, a regulator, and one of a DC/DC converter and a DC/AC inverter is provided in the present invention. In which, the AC generator receives the kinetic energy generated by the autogenic energy generating device so as to generate an AC output voltage firstly. The AC output voltage is rectified via a rectifier into a DC output voltage secondly. The DC output voltage is regulated by a voltage regulator thirdly. The regulated DC output voltage is input to one of a DC/DC converter and a DC/AC inverter to generate the DC/AC input voltage of the electronic equipment lastly. The DC/DC converter (or the DC/AC inverter) is employed to either boost or convert the regulated DC output voltage into the DC/AC input voltage. Both of the access point and the wireless audio receive the required DC/AC power supply continuously from the self-sustained power supply apparatus. The self-sustained power supply apparatus includes a switch, which turns off the apparatus when it is necessary to cut off the power supply of the access point or the wireless audio, for the maintenance or saving the energy resources.

Keeping the drawbacks of the prior arts in mind, and employing experiments and research full-heartily and persistently, the access point and the wireless audio both having the self-sustained power supply apparatus are finally conceived by the applicant.

### SUMMARY OF THE INVENTION

It is therefore an object of the present invention to provide an access point and a wireless audio to overcome the drawbacks of the prior art such that the installation location of one of the access point and the wireless audio is not limited by the location of the external power supply, there is no need of using the disposable and rechargeable batteries, and there is no waste battery generated so as to protect the global environment.

According to the first aspect of the present invention, an access point having a self-sustained power supply apparatus for a network having a plurality of computers includes a base station coupled to the apparatus and receiving a power supply from the apparatus and an antenna set coupled to the base station, in which the base station maintains a first linking status with the computers via a first wireless transmission.

Preferably, the power supply is a first DC power supply.

Preferably, the self-sustained power supply apparatus further includes an autogenic energy generating apparatus generating an AC power supply, a switch determining one of a turn-on and a turn-off states of the generating apparatus, a rectifier rectifying the AC power supply into a second DC power supply, a regulator regulating the second DC power supply and generating a third DC power supply and a DC/DC converter receiving the third DC power supply and generating the first DC power supply through one of a step-up and a step-down.

Preferably, the DC/DC converter is one selected from a group consisting of a boost converter, a buck-boost converter and a flyback converter when the DC/DC converter is going through the step-up.

Preferably, the DC/DC converter is one selected from a group consisting of a buck converter, a buck-boost converter, a forward converter, a flyback converter, a half-bridge converter and a full-bridge converter when the DC/DC converter is going through the step-down.

Preferably, the base station is further coupled to a LAN switch of a wired local area network (LAN), and the LAN switch is one of a switch and a hub.

Preferably, the first power supply is a first DC power supply.

Preferably, each of the plurality of computers is one of a desktop computer and a notebook computer, and has a wireless network device.

Preferably, the self-sustained power supply apparatus is one of a built-in apparatus and a plug-in apparatus.

Preferably, the built-in apparatus is installed in a specific location inside the access point, and the plug-in apparatus includes a case and a fixing device fixing the case at a surrounding location of the access point.

According to the second aspect of the present invention, a wireless audio system includes a main unit having a first self-sustained power supply apparatus and a loudspeaker enclosure having a second self-sustained power supply apparatus, in which the main unit wirelessly communicates with the loudspeaker enclosure.

Preferably, the main unit further includes a power amplifier receiving a first power supply from the first self-sustained power supply apparatus coupled thereto, receiving an input audio signal from an external audio signal source coupled thereto and amplifying the input audio signal to generate a first output audio signal and a wireless transmission apparatus receiving the first power supply from the first self-sustained power supply apparatus coupled thereto and receiving the first output audio signal from the power amplifier coupled thereto to generate a radio frequency signal.

Preferably, the external audio signal source is one selected from a group consisting of a television, a radio, a DVD apparatus, a VCD apparatus, a CD player, a computer and a game console.

Preferably, the first power supply is a first DC power supply.

Preferably, the first self-sustained power supply apparatus includes an autogenic energy generating apparatus generating an AC power supply, a switch determining one of a turn-on and a turn-off states of the generating apparatus, a rectifier rectifying the AC power supply into a second DC power supply, a regulator regulating the second DC power supply and generating a third DC power supply and a DC/DC converter receiving the third DC power supply and generating the first DC power supply through one of a step-up and a step-down.

Preferably, the loudspeaker enclosure further includes a wireless receiving apparatus receiving a second power supply from the second self-sustained power supply apparatus coupled thereto, receiving the radio frequency signal and generating a second audio signal and a loudspeaker receiving the second power supply from the second self-sustained power supply apparatus coupled thereto, coupled to the wireless receiving apparatus, and receiving and outputting the second audio signal.

Preferably, the second power supply is a first DC power supply.

Preferably, the second self-sustained power supply apparatus includes an autogenic energy generating apparatus generating an AC power supply, a switch determining one of a turn-on and a turn-off states of the generating apparatus, a rectifier rectifying the AC power supply into a second DC power supply, a regulator regulating the second DC power supply and generating a third DC power supply and a DC/DC converter receiving the third DC power supply and generating the first DC power supply through one of a step-up and a step-down.

Preferably, the main unit further includes a remote control for turning on and turning off the main unit, selecting a channel and adjusting a volume.

The present invention may be best understood through the following descriptions with reference to the accompanying drawings, in which:

### BRIEF DESCRIPTION OF THE DRAWINGS

FIG. 1 is the schematic diagram showing the configuration of a conventional LAN;

FIG. 2 is the schematic diagram showing the configuration of a conventional wireless audio employing batteries and wireless transmitting technology;

FIG. 3 is the schematic diagram showing the configuration of an autogenic energy generating device in the prior art;

FIGS. 4(a) and 4(b) are the schematic circuit diagrams of an access point having a plug-in self-sustained power supply apparatus and a built-in self-sustained power supply apparatus according to the first and the second preferred embodiments of the access point of the present invention respectively;

FIGS. 5(a) and 5(b) are showing the circuit diagrams of a half-wave bridge rectifier and a full-wave bridge rectifier, and employed in the preferred embodiments of the present invention respectively;

FIGS. 6(a) to 6(c) are showing the circuit diagrams of a NPN voltage regulator, a LDO voltage regulator and a Quasi LDO voltage regulator, which are linear voltage regulators, and employed in the preferred embodiments of the present invention respectively;

FIGS. 7(a) to 7(c) are showing the circuit diagrams of a buck converter, a boost converter and a buck-boost converter, which are DC/DC converters, and employed in the preferred embodiments of the present invention respectively

FIG. 8 is showing the schematic diagram of an access point having a self-sustained power supply apparatus according to the preferred embodiments of the access point of the present invention; and

FIG. 9 is showing the schematic circuit diagram of a wireless audio having a self-sustained power supply apparatus according to the preferred embodiment of the wireless audio of the present invention.

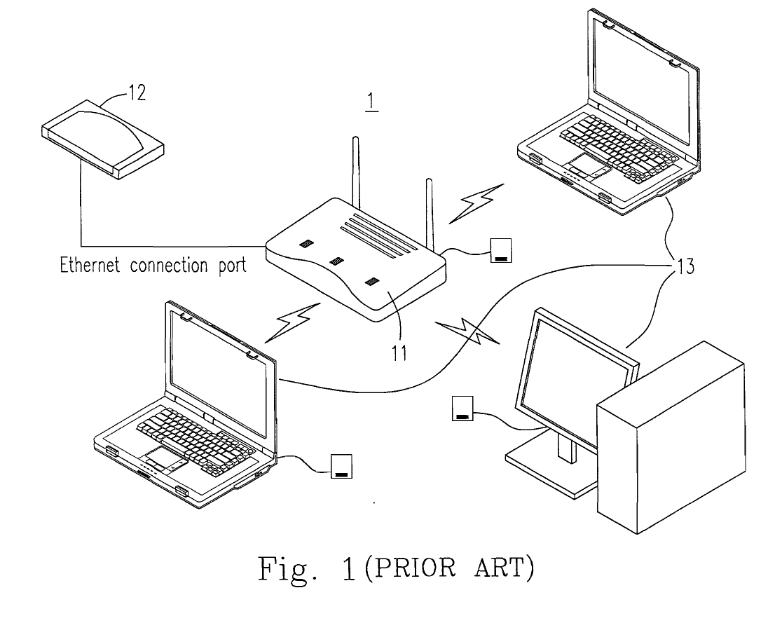

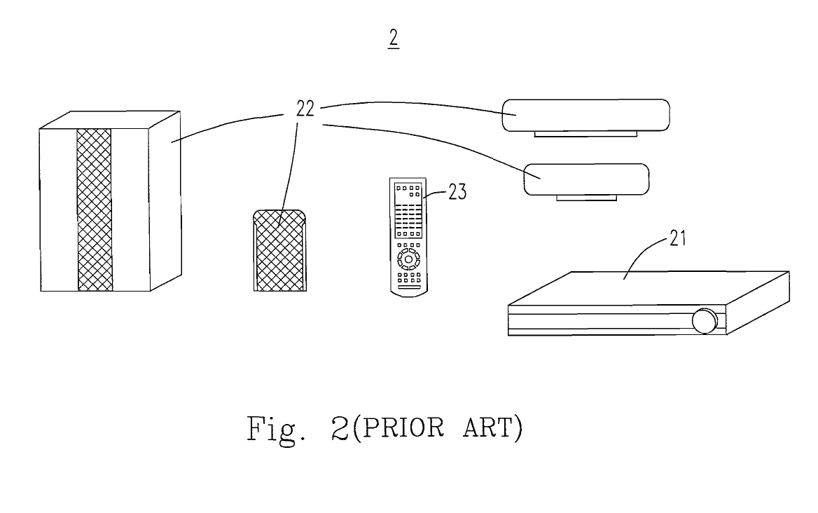

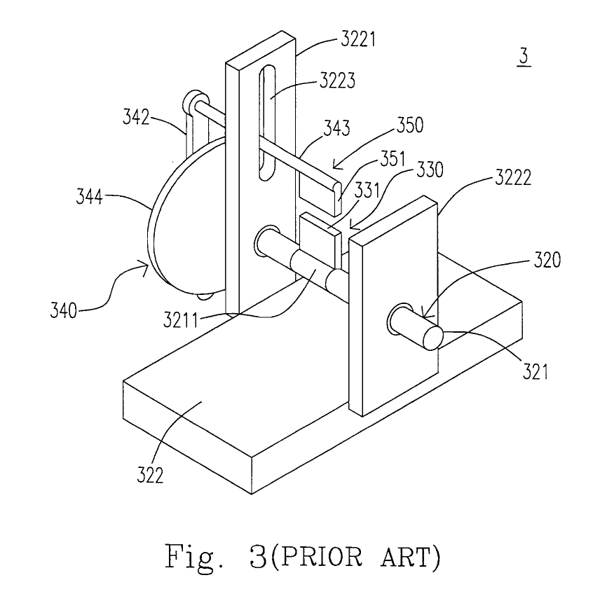

### DETAILED DESCRIPTION OF THE PREFERRED EMBODIMENT

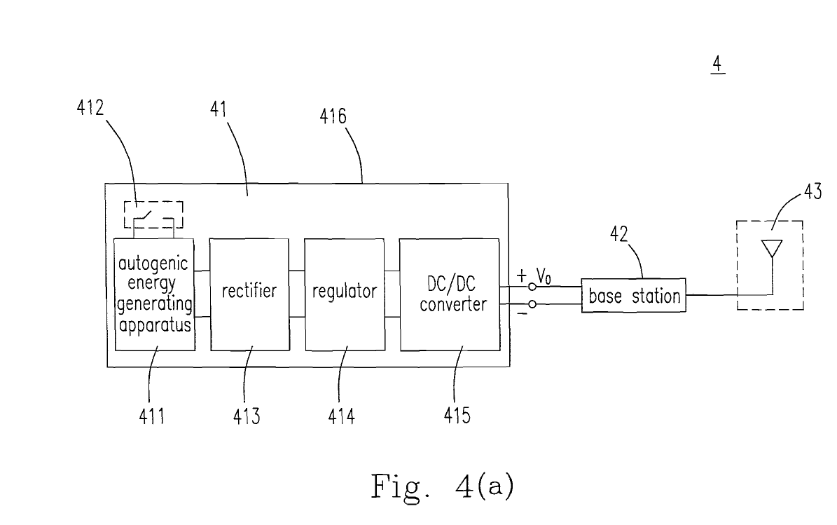

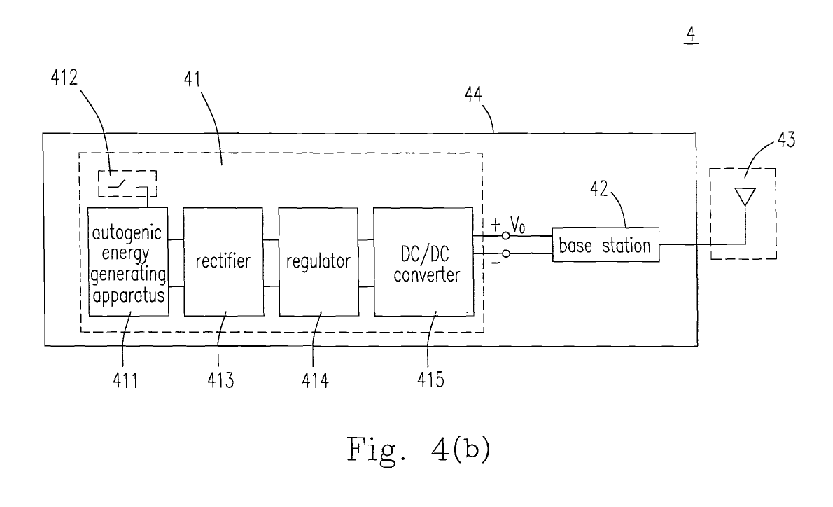

Please refer to FIG. 4(a), which shows the schematic circuit diagram of an access point having a plug-in self-sustained power supply apparatus according to the first preferred embodiment of the access point of the present invention. In FIG. 4(a), the access point 4 includes a plug-in self-sustained power supply apparatus 41, a base station 42 and an antenna set 43. In which, the plug-in self-sustained power supply apparatus 41 includes an autogenic energy generating apparatus 411 having an autogenic energy generating device (not shown) generating a kinetic energy and an AC generator (not shown) receiving the kinetic energy and generating an AC power supply continuously, a switch 412 coupled to the autogenic energy generating apparatus 411 and turning on and off the autogenic energy generating apparatus 411, a rectifier 413 coupled to the autogenic energy generating apparatus 411 rectifying the AC power supply into a second DC power supply, a regulator 414 coupled to the rectifier 413 regulating the second DC power supply to generate a third DC power supply, a DC/DC converter 415 coupled to the regulator 414, receiving the third DC power supply and going through one of a step-up and a step-down to generate a first DC output power supply Vo and a case 416 containing the components 411 to 415 of the self-sustained power supply system 41. Furthermore, the antenna set 43 includes at least an antenna.

Referring to FIG. 4(b), which shows the schematic circuit diagram of an access point having a built-in self-sustained power supply apparatus according to the second preferred embodiment of the access point of the present invention. In FIG. 4(b), the access point 4 includes a built-in self-sustained power supply apparatus 41, a base station 42, an antenna set 43 and a case 44 containing the self-sustained power supply apparatus 41 and the base station 42. In which, the built-in self-sustained power supply apparatus 41 includes an autogenic energy generating apparatus 411 having an autogenic energy generating device (not shown) generating a kinetic energy and an AC generator (not shown) receiving the kinetic energy and generating an AC power supply continuously, a switch 412 coupled to the autogenic energy generating apparatus 411 and turning on and off the autogenic energy generating apparatus 411, a rectifier 413 coupled to the autogenic energy generating apparatus 411 rectifying the AC power supply into a second DC power supply, a regulator 414 coupled to the rectifier 413 regulating the second DC power supply to generate a third DC power supply, and a DC/DC converter 415 coupled to the regulator 414, receiving the third DC power supply and going through one of a step-up and a step-down to generate the first DC output power supply Vo. Furthermore, the antenna set 43 also includes at least an antenna.

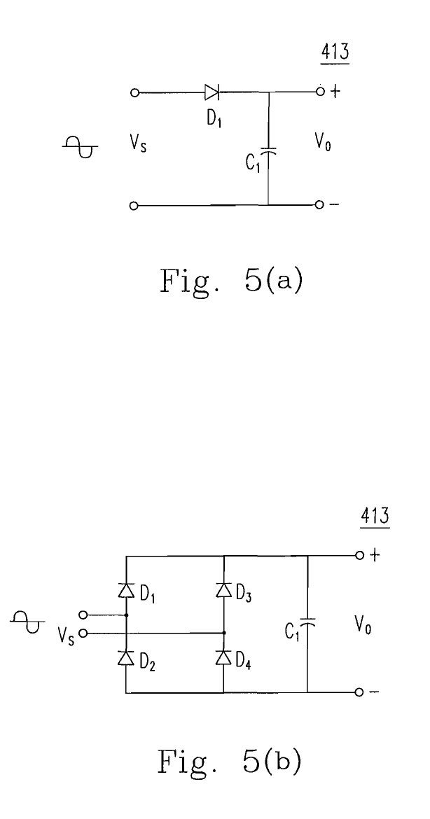

As for the rectifier 413 of the first and the second preferred embodiments of the access point of the present invention as shown in FIGS. 4(a) and 4(b), it could be one of a half-wave bridge rectifier and a full-wave bridge rectifier. FIGS. 5(a) and 5(b) are the schematic circuit diagrams of the half-wave bridge rectifier and the full-wave bridge rectifier. In FIG. 5(a), the half-wave bridge rectifier includes a diode D1 and a filter capacitor C1, the input voltage of the half-wave bridge rectifier is an AC voltage Vs, and the output voltage of the half-wave bridge rectifier is DC voltage V₀. In FIG. 5(b), the full-wave bridge rectifier includes four diodes D1-D4 and a filter capacitor C1, the input voltage of the full-wave bridge rectifier is an AC voltage Vs, and the output voltage of the full-wave bridge rectifier is a DC voltage Vo. Besides, other different types of rectifiers are also applicable to the first and the second preferred embodiments of the access point of the present invention. Since the technology regarding the conventional rectifiers is a well-known prior art, the details regarding the contents of the technology would be omitted here.

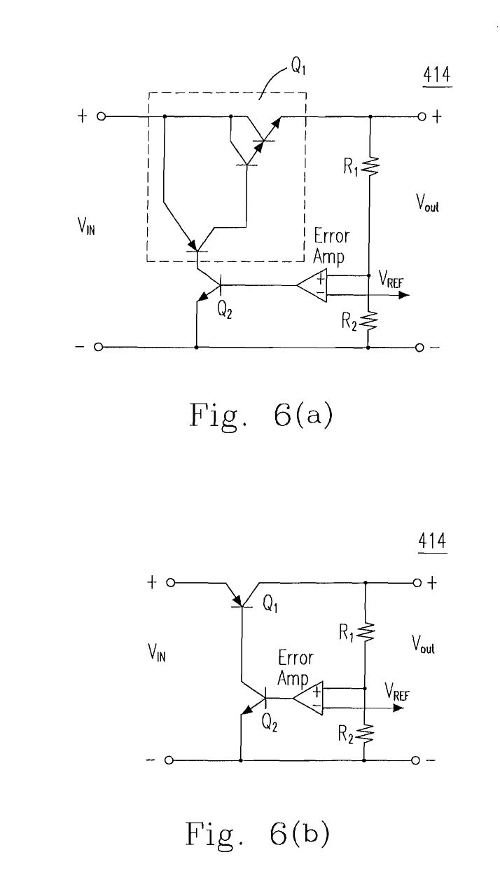

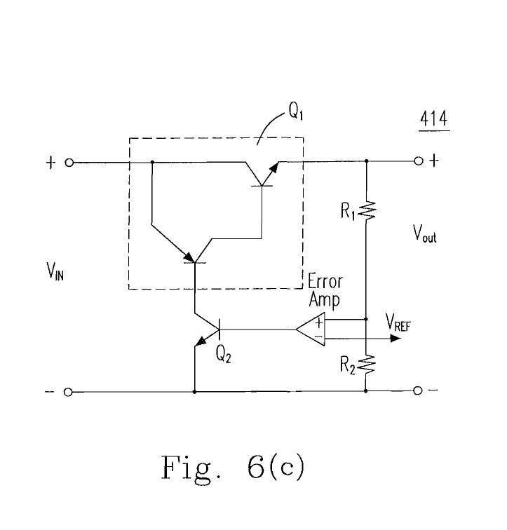

As for the regulator 414 of the first and the second preferred embodiments of the access point of the present invention as shown in FIGS. 4(a) to 4(b), it could be a linear voltage regulator, that is to say it could be one selected from a group consisting of an NPN voltage regulator, a LDO voltage regulator and a Quasi LDO voltage regulator. FIGS. 6(a) to 6(c) are the schematic circuit diagrams of the NPN voltage regulator, the LDO voltage regulator and the Quasi LDO voltage regulator. In FIG. 6(a), the NPN voltage regulator includes a pass device Q1 (having a Darlington transistor and a PNP transistor), a NPN transistor Q2, an error amplifier Error Amp and a voltage divider (having resistors R1 and R2). In which, the output terminal of the Error Amp is coupled to the base of the transistor Q2, the inverting input terminal of the Error Amp is coupled to a connecting terminal of R1 and R2, and the non-inverting input terminal of the Error Amp is coupled to a reference voltage V_{REF}, the input voltage of the NPN voltage regulator is a DC voltage V_{IN}, and the output voltage of the NPN voltage regulator is a DC voltage V_{OUT}. In FIG. 6(b), the pass device Q1 of the LDO voltage regulator is a PNP transistor, and the remaining part is the same as the above-mentioned NPN voltage regulator. In FIG. 6(c), the pass device Q1 of the Quasi LDO voltage regulator includes a PNP transistor and a NPN transistor coupled to each other, the remaining part is the same as the above-mentioned NPN voltage regulator. Besides, other different types of regulators are also applicable to the first and the second preferred embodiments of the access point of the present invention. Since the technology regarding the conventional regulators is a well-known prior art, the details regarding the contents of the technology would be omitted here.

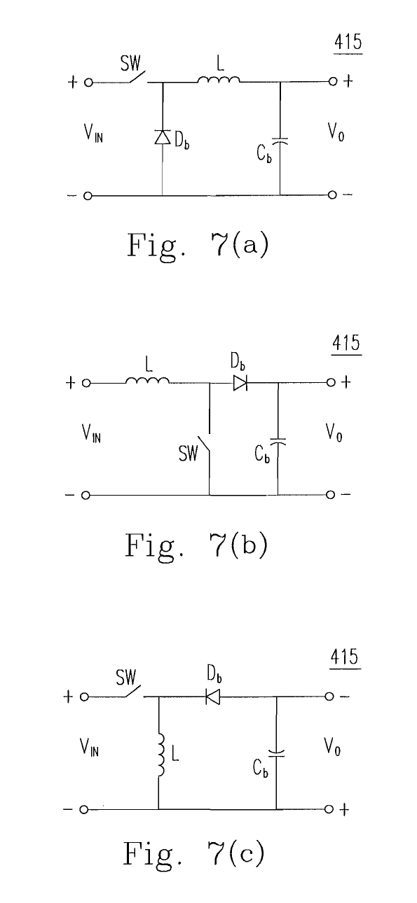

As for the DC/DC converter 415 of the first and the second preferred embodiments of the access point of the present invention as shown in FIGS. 4(a) and 4(b), it could be one of a boost converter and a buck-boost converter (for boosting). FIGS. 7(a) to 7(c) are the schematic circuit diagrams of the buck converter, the boost converter and the buck-boost converter. In FIG. 7(a), the buck converter includes a switch SW, a diode Db, an inductor L and an output capacitor Cb. In which, the input voltage of the buck converter is a DC voltage V_{IN}, and the output voltage of the boost converter is a DC voltage Vo. In FIG. 7(b), the boost converter includes the same components as the aforementioned buck converter, and except that the connecting configuration of the boost converter is different from that of the buck converter, the remaining part is the same as the above-mentioned buck converter. In FIG. 7(c), the buck-boost converter includes the same components as the aforementioned buck converter, and except that the connecting configuration of the buck-boost converter is different from that of the buck converter, the remaining part is the same as the above-mentioned buck converter. Besides, other different types of converters are also applicable to the first and the second preferred embodiments of the access point of the present invention. Since the technology regarding the conventional converters is a well-known prior art, the details regarding the contents of the technology would be omitted here.

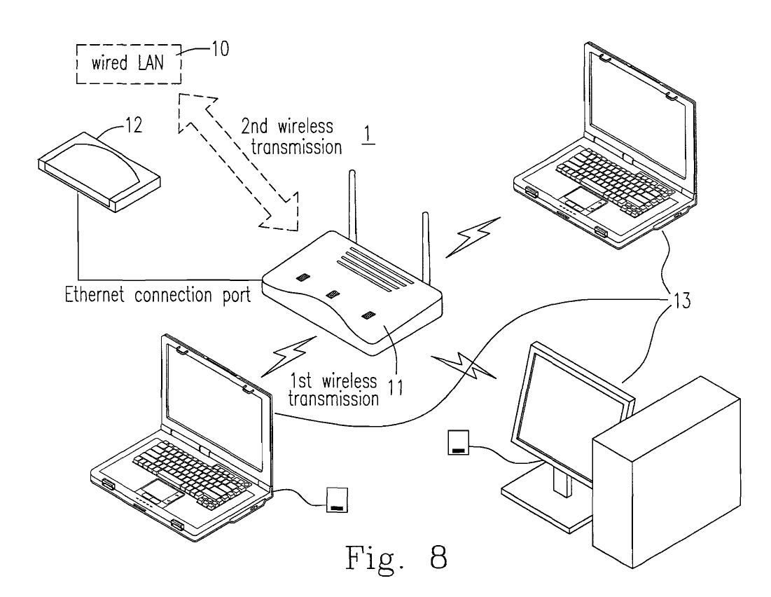

Please refer to FIG. 8, which is the schematic circuit diagram of access point having a built-in self-sustained power supply apparatus according to the second preferred embodiment of the access point of the present invention. Referring to FIG. 8, the LAN 1 includes an access point 11 (including the built-in self-sustained power supply apparatus), a LAN switch 12 connecting to a wired LAN 10, an Ethernet connection port coupled to the LAN switch 12 and a plurality of computers each having a wireless network device (including notebooks and desktop computers) 13. In which, the access point 11 maintains a first linking status with the computers 13 via a first wireless transmission, and the LAN 1 maintains a second linking status with the wired LAN 10 via a second wireless transmission (the dash-lined arrow and dash-lined rectangle as shown in FIG. 8 respectively).

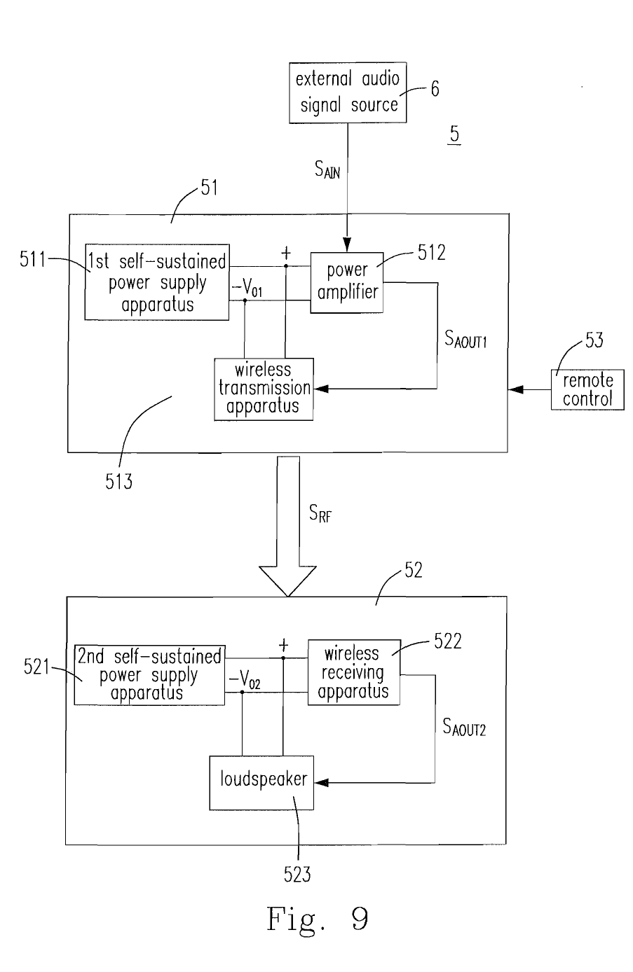

Please refer to FIG. 9, it shows the schematic circuit diagram of a wireless audio having a self-sustained power supply apparatus according to the preferred embodiment of the wireless audio of the present invention. The wireless audio 5 has a main unit 51, at least one loudspeaker enclosure 52 and a remote control 53. In which, the main unit includes a first self-sustained power supply apparatus 511, which is one of the self-sustained power supply apparatuses as shown in FIGS. 4(a) and 4(b), and is employed in generating a first DC output power supply V_{O1}, a power amplifier 512 coupled to the first self-sustained power supply apparatus 511, receiving the first DC output power supply V_{O1}, coupled to an external audio source 6, receiving an input audio signal S_{AIN}, and amplifying the input audio signal to generate a first output audio signal S_{AOUT1}, and a wireless transmission apparatus 513 coupled to the first self-sustained power supply apparatus 511, receiving the first DC output power supply V_{O1}, coupled to the power amplifier 512, receiving the first output audio signal S_{AOUT1} so as to generate a radio frequency signal S_{RF}. In which, the external audio signal source 6 is one selected from a group consisting of a television, a radio, a DVD apparatus, a VCD apparatus, a CD player, a computer and a game console (all are not shown). Besides, the loudspeaker enclosure 52 includes a second self-sustained power supply apparatus 521, which is one of the self-sustained power supply apparatuses as shown in FIGS. 4(a) and 4(b), and is employed in generating a second DC output power supply V_{O2}, a wireless receiving apparatus 522 coupled to the second self-sustained power supply apparatus 521, receiving the second DC output power supply V_{O2} and receiving the radio frequency signal S_{RF} so as to generate a second output audio signal S_{AOUT2}, and a loudspeaker 523 coupled to the second self-sustained power supply apparatus 521, receiving the second DC output power supply V_{O2} and coupled to the wireless receiving apparatus 522 receiving the second output audio signal S_{AOUT2}. In which, the second output audio signal S_{AOUT2} is output through the loudspeaker 523. Furthermore, the wireless audio 5 further includes a remote control 53, and the remote control is employed to turn on and turn off the main unit 51, select a channel and adjust a volume.

From the above descriptions, the present invention provides an access point and a wireless audio to overcome the drawbacks of the prior art such that the installation location of one of the access point and the wireless audio could not be limited by the location of the external power supply, there is no need of the disposable and rechargeable batteries, and there is no waste battery generated so as to protect the global environment.

Although the invention has been shown and described in terms of specific embodiments, it will be evident that changes and modifications are possible which do not in fact depart from the inventive concepts taught herein. It will be appreciated by those skilled in the art that various omissions, additions and modifications may be made to the processes described above without departing from the scope of the invention, and all such modifications and changes are intended to fall within the scope of the invention, as defined in appended claims.

What is claimed is:

1. An access point having a self-sustained power supply apparatus for a network having a plurality of computers, comprising:
a base station coupled to the apparatus and receiving a power supply from the apparatus; and
an antenna set coupled to the base station,
wherein the base station maintains a first linking status with the computers via a first wireless transmission.

2. An access point according to claim 1, wherein the power supply is a first DC power supply.

3. An access point according to claim 2, wherein the self-sustained power supply apparatus further comprises:
an autogenic energy generating apparatus generating an AC power supply;
a switch determining one of a turn-on and a turn-off states of the generating apparatus;
a rectifier rectifying the AC power supply into a second DC power supply;
a regulator regulating the second DC power supply and generating a third DC power supply; and
a DC/DC converter receiving the third DC power supply and generating the first DC power supply through one of a step-up and a step-down.

4. An access point according to claim 3, wherein the DC/DC converter is one selected from a group consisting of a boost converter, a buck-boost converter and a flyback converter when the DC/DC converter is going through the step-up.

5. An access point according to claim 3, wherein the DC/DC converter is one selected from a group consisting of a buck converter, a buck-boost converter, a forward converter, a flyback converter, a half-bridge converter and a full-bridge converter when the DC/DC converter is going through the step-down.

6. An access point according to claim 1, wherein the base station is further coupled to a LAN switch of a wired local area network (LAN), and the LAN switch is one of a switch and a hub.

7. An access point according to claim 1, wherein the base station further maintains a second linking status with a wired LAN via a second wireless transmission.

8. An access point according to claim 1, wherein each of the plurality of computers is one of a desktop computer and a notebook computer, and has a wireless network device.

9. An access point according to claim 1, wherein the self-sustained power supply apparatus is one of a built-in apparatus and a plug-in apparatus.

10. An access point according to claim 9, wherein the built-in apparatus is installed in a specific location inside the access point, and the plug-in apparatus comprises:
a case; and
a fixing device fixing the case at a surrounding location of the access point.

11. A wireless audio system, comprising:
a main unit having a first self-sustained power supply apparatus; and
a loudspeaker enclosure having a second self-sustained power supply apparatus, wherein the main unit wirelessly communicates with the loudspeaker enclosure.

12. A wireless audio system according to claim 11, wherein the main unit further comprises:
a power amplifier receiving a first power supply from the first self-sustained power supply apparatus coupled thereto, receiving an input audio signal from an external audio signal source coupled thereto and amplifying the input audio signal to generate a first output audio signal; and
a wireless transmission apparatus receiving the first power supply from the first self-sustained power supply apparatus coupled thereto and receiving the first output audio signal from the power amplifier coupled thereto to generate a radio frequency signal.

13. A wireless audio system according to claim 12, wherein the external audio signal source is one selected from a group consisting of a television, a-radio, a DVD apparatus, a VCD apparatus, a CD player, a computer and a game console.

14. A wireless audio system according to claim 12, wherein the first power supply is a first DC power supply.

15. A wireless audio system according to claim 14, wherein the first self-sustained power supply apparatus comprises:
an autogenic energy generating apparatus generating an AC power supply;
a switch determining one of a turn-on and a turn-off states of the generating apparatus;
a rectifier rectifying the AC power supply into a second DC power supply;
a regulator regulating the second DC power supply and generating a third DC power supply; and
a DC/DC converter receiving the third DC power supply and generating the first DC power supply through one of a step-up and a step-down.

16. A wireless audio system according to claim 12, wherein the loudspeaker enclosure further comprises:
a wireless receiving apparatus receiving a second power supply from the second self-sustained power supply apparatus coupled thereto, receiving the radio frequency signal and generating a second audio signal; and
a loudspeaker receiving the second power supply from the second self-sustained power supply apparatus coupled thereto, coupled to the wireless receiving apparatus, and receiving and outputting the second audio signal.

17. A wireless audio system according to claim 16, wherein the second power supply is a first DC power supply.

18. The wireless audio system according to claim 17, wherein the second self-sustained power supply apparatus comprises:
an autogenic energy generating apparatus generating an AC power supply;
a switch determining one of a turn-on and a turn-off states of the generating apparatus;
a rectifier rectifying the AC power supply into a second DC power supply;
a regulator regulating the second DC power supply and generating a third DC power supply; and
a DC/DC converter receiving the third DC power supply and generating the first DC power supply through one of a step-up and a step-down.

19. A wireless audio system according to claim 11, wherein the main unit further comprises a remote control for turning on and turning off the main unit, selecting a channel and adjusting a volume.
